(19) United States
(12) Patent Application Publication
(10) Pub. No.: US 2006/0166058 A1
(43) Pub. Date: Jul. 27, 2006

(54) Fuel cell system ensuring stability of operation

(75) Inventor: Hiroyasu Kudo, Iwakura-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/337,712

(22) Filed: Jan. 24, 2006

(30) Foreign Application Priority Data
Jan. 25, 2005 (JP) 2005-017056

(51) Int. Cl. H01M 8/04; H01M 8/24

(52) U.S. Cl. 429/22; 429/38; 429/23; 429/25; 429/26; 429/24

(57) ABSTRACT

A fuel cell system designed to supply non- or low-humidified air to a fuel cell stack and ensure the stability of operation thereof. The system works to monitor operating conditions of the fuel cell stack and determine whether electrolyte films of fuel cells are getting dried or not or whether an undesirable quantity of water has been produced on the side of air electrodes of the cells or not. When either condition is true, the system works to elevate the pressure of air in an air drain line of the fuel cell stack to enhance the production of water in the cells to keep the electrolyte films or-to transfer the water from the air electrodes to the fuel electrodes of the cells to keep the electrolyte films in a desired wet condition, thereby ensuring the stability of operation of the fuel cell stack.

### CROSS REFERENCE TO RELATED DOCUMENT

The present application claims the benefit of Japanese Patent Application No. 2005-17056 filed on Jan. 25, 2005 the disclosure of which is incorporated herein by reference.

### BACKGROUND OF THE INVENTION

1. Technical Field of the Invention

The present invention relates generally to a fuel cell system designed to ensure the stability of operation thereof.

2. Background Art

Typical fuel cells designed to generate electrical energy through electrochemical reactions between oxidant and fuel gas are generally supplied with air as the oxidant and hydrogen gas as the fuel gas. An output of the fuel cells depends upon the concentration of oxygen contained in air. The improvement of the output of the fuel cells is, therefore, achieved by increasing the concentration of oxygen in the air to be supplied to the fuel cells.

For example, Japanese Patent First Publication Nos. 2003-229165 and 10-321249 (equivalent to U.S. Pat. No. 6,106,963) teach techniques for producing and adding pure oxygen to air to increase the concentration of oxygen in the air to be supplied to fuel cells. Japanese Patent First Publication No. 2003-217624 teaches techniques for increasing the amount of air to be supplied to fuel cells.

The former techniques, however, require complex mechanisms to create the pure oxygen or installation spaces occupied by the mechanisms. The latter techniques requires a compressor to increase the amount of air to be supplied to the fuel cells, thus resulting in an increase in total power consumed by the system, which leads to a decrease in efficiency of operation of the system.

### SUMMARY OF THE INVENTION

In order to alleviate the above problems, the inventor of this application studied a fuel cell system designed to supply non-humidified air to fuel cells to increase the concentration of oxygen in the air. The fuel cell system works to decrease the amount of water vapor contained in the air to be supplied to the fuel cells to increase the apparent concentration of oxygen in the air based on the fact that water vapor contained in air causes the apparent concentration of oxygen in the whole of the air to decrease.

Typical fuel cell systems equipped with polymer electrolyte fuel cells are usually designed to humidify the air supplied to the fuel cells in order to avoid drying of electrolyte films of the fuel cells. Such systems, however, have two problems, as discussed below.

The supply of non-humidified air to the cells facilitates ease of drying of the electrolyte films of the fuel cells. The fuel cells are usually arrayed to overlap each other to make a fuel cell stack. The fuel cell stack is constructed to supply the air and fuel gas to each of the fuel cells. A portion of the electrolyte film near an air inlet of each of the fuel cells is most sensitive to drying. The remaining portion is less dried than near the air inlet because water, as generated by power generation of the cell, flows through an air flow path formed in the cell and collects on it. Usually, such drying of the electrolyte films most occurs at start of operation of the fuel cell stack because before the start, water is not yet produced by the activities of the fuel cells.

The second problem is that the water, as produced by the power generation of the fuel cells, is evaporated and mixed with the air, thereby resulting in a decrease in apparent concentration of oxygen in the whole of the air supplied to the fuel cells.

Specifically, each of the fuel cells is typically made up of an assembly of air electrode, a fuel electrode, and an electrolyte film disposed between the air and fuel electrodes and separators retaining the assembly. The separators have an air flow path and a fuel gas flow path formed therein, respectively. When the air is supplied to the air electrode, and the fuel gas is supplied to the fuel electrode, it will result in production of water on the air electrode. When the water is evaporated and mixed with the air flowing through the air flow path of the cell, it result in a drop in apparent concentration of oxygen in the whole of the air. This eliminates the value of supplying the non-humidified air to the fuel cells.

The above problems most appears especially at an air outlet of the air flow path of each of the cells because the water in the air flow path flows toward and collects at the air outlet.

The increasing of the apparent concentration of oxygen in the air may also be achieved by controlling the amount of humidification of the air within a range lower than a typical one. This method, however, also encounters the above problems.

It is therefore a principal object of the invention to avoid the disadvantages of the prior art.

It is another object of the invention to provide an improved structure of a fuel cell system designed to ensure the stability of operation thereof.

According to one aspect of the invention, there is provided a fuel cell system which may be employed in electric automobiles. The fuel cell system comprises: (a) a fuel cell stack made up of a plurality of cells each including a fuel gas flow path through which fuel gas flows and an air flow path through which air flows, each of the cells also including a fuel electrode exposed to the fuel gas flow path, an air electrode exposed to the air flow path, and an electrolyte disposed between the fuel electrode and the air electrode; (b) an air supply line through which the air is supplied to the air flow path of each of the cells; (c) an air drain line through which the air flowing out of the air flow paths of the cells is drained; (d) a fuel supply path through which the fuel gas is supplied to the fuel gas flow path of each of the cells; (e) an air flow rate regulator working to regulate a flow rate of the air flowing through the air drain line; and (f) a controller working to determine whether the electrolyte of at least one of the cells is being dried or not. When the electrolyte is determined to be being dried, the controller actuates the air flow rate regulator to elevate the pressure of the air in the air flow path of each of the cells above a level required in a normal operation of the fuel cell stack to decrease the velocity of flow of the air in the air flow path. This results in an increased time the oxygen contained in the air stays on the surface of the air electrode of each of the cells at the air inlet of the air flow path, thereby increasing the concentration of oxygen in the air flowing through the air flow path. This enhances the electrochemical reactions near the air inlet of the cells to increase a produced amount of water. The water will diffuse over the electrolytes of the cells to keep it in a desired wet condition, thereby ensuring the stability of operation of the fuel cell stack.

In the preferred mode of the invention, the air flow rate regulator may be implemented by a pressure regulator working to regulate a pressure of the air flowing in the air drain line. The air flow regulator may alternatively be implemented by a throttle.

The fuel cell system may further comprise a current sensor designed to measure an electric current, as generated in an area defined near an air inlet of the air flow path of at least one of the cells. The controller may sample the electric current, as measured by the current sensor, to determine whether the electrolyte of at least one of the cells is being dried or not.

The fuel cell system may also include a voltage sensor working to measure a voltage, as generated by one of the cells. The controller may compare the voltage, as measured by the voltage sensor, with a given threshold value to determine whether the electrolyte of at least one of the cells is being dried or not.

The fuel cell system may also include a total voltage sensor working to measure a total voltage, as generated by the cells. The controller may compare the voltage, as measured by the total voltage sensor, with a given threshold value to determine whether the electrolytes of the cells are being dried or not.

The fuel cell system may also include an impedance measuring circuit working to measure an impedance of one of the cells. The controller may compare the impedance, as measured by the impedance measuring circuit, with a given threshold value to determine whether the electrolyte of at least one of the cells is being dried or not.

The fuel cell system may also include a pressure difference regulator working to regulate a difference in pressure between the air in the air flow paths of the cells and the fuel gas in the fuel gas flow paths of the cells. The controller may work to determine whether water exists in the air flow paths or not. When it is determined that the water exists in the air flow paths, the controller actuates the pressure difference regulator to elevate the pressure of the air in the air flow path of each of the cells above a pressure of the fuel gas in the fuel gas flow path of each of the cells.

The pressure difference regulator may be implemented by an air flow rate regulator disposed in the air drain line. The controller may actuate the air flow rate regulator to increase the pressure in the air flow paths of the cells more than that in the fuel gas flow paths.

The fuel cell system may also include a first pressure sensor working to measure a pressure of the air in the air supply line and a second pressure sensor working to measure a pressure of the air in the air drain line. When a difference between the pressures, as measured by the first and second pressure sensors, has decreased below that before the controller elevates the pressure of the air in the air flow path of each of the cells, the controller stops elevating the pressure of the air in the air flow path.

The fuel cell system may also include an evaporation controller working to increase an amount of water to be evaporated in the fuel gas flow paths of the cells above that in the air flow paths of the cells. The controller may work to determine whether there is water in the air flow paths or not. When it is determined that the water exists in the air flow paths, the controller actuates the evaporation controller to increase the amount of water to be evaporated in the fuel gas flow paths above that in the air flow paths.

The evaporation controller may include a gas heater working to heat the fuel gas flowing through the fuel gas supply line. The controller actuates the gas heater to heat the fuel gas flowing through the fuel gas supply line to elevate a temperature in the fuel gas flow paths above that in the air flow paths, thereby increasing the amount of water to be evaporated in the fuel gas flow paths above that in the air flow paths.

The fuel cell system also include a cell current determining circuit working to determine an electric current generated by the cells. The controller may determine the amount of water having been produced in the cells based on the electric current, as determined by the cell current determining circuit, calculate a desired amount of water to be evaporated in the fuel gas flow paths based on the produced amount of water and an amount of water to be retained by the electrolytes of the cells, and determine a target temperature in the fuel gas flow paths needed to achieve evaporation of the desired amount of water. The controller actuates the gas heater to heat the fuel gas flowing through the fuel gas supply line so as to establish the target temperature in the fuel gas flow paths.

The evaporation controller may include a gas flow rate controller working to control a flow rate of the fuel gas flowing through the fuel gas supply line. The controller may actuate the gas flow controller to increase the amount of the fuel gas supplied to the fuel cell stack, thereby increasing the amount of water to be evaporated in the fuel gas flow paths above that in the air flow paths. When the difference between the pressures, as measured by the first and second pressure sensors, has decreased below that before the controller increases the amount of water to be evaporated in the fuel gas flow paths, the controller may stop increasing the amount of water to be evaporated in the fuel gas flow paths.

The fuel cell system may also include a current sensor working to measure an electric current generated in an area defined near an air outlet of the air flow path of at least one of the cells and a temperature sensor working to measure a temperature in the air outlet of the air flow path. The controller determines whether the water exists in the air flow paths or not based on the electric current, as measured by the current sensor, and the temperature, as measured by the temperature sensor.

The fuel cell system may also include a cell current sensor working to measure an electric current, as developed by one of the cells. The controller compares the voltage, as measured by the voltage sensor, with a given threshold value to determine whether the water exists in the air flow paths or not.

The fuel cell system may alternatively include a total voltage sensor working to measure a total voltage, as generated by the cells. The controller determines whether the water exists in the air flow paths or not based on the measured total voltage.

The fuel cell system may also include a humidifier working to humidify the fuel gas flowing through the fuel gas supply line into the fuel cell stack.

According to the second aspect of the invention, there is provided a fuel cell system which comprises: (a) a fuel cell stack made up of a plurality of cells each including a fuel gas flow path through which fuel gas flows and an air flow path through which air flows, each of the cells also including a fuel electrode exposed to the fuel gas flow path, an air electrode exposed to the air flow path, and an electrolyte disposed between the fuel electrode and the air electrode; (b) an air supply line through which the air is supplied to the air flow path of each of the cells; (c) an air drain line through which the air flowing out of the air flow paths of the cells is drained; (d) a fuel supply path through which the fuel gas is supplied to the fuel gas flow path of each of the cells; (e) a pressure difference regulator working to regulate a difference in pressure between the air in the air flow paths of the cells and the fuel gas in the fuel gas flow paths of the cells; and (f a controller working to determine whether water exists in the air flow paths or not. When it is determined that the water exists in the air flow paths, the controller actuates the pressure difference regulator to elevate the pressure of the air in the air flow path of each of the cells above a pressure of the fuel gas in the fuel gas flow path of each of the cells, thereby causing the water existing around the air electrode of the cell in the air flow path to transfer to the fuel gas path through the electrolyte. This minimizes the quantity of water to be evaporated and mixed with the air flowing in the air flow path to assure a desired concentration of oxygen in the air, thus resulting in the stability of operation of the fuel cell stack.

In the preferred mode of the invention, the pressure difference regulator may be implemented by an air flow rate regulator disposed in the air drain line. The controller may actuate the air flow rate regulator to increase the pressure in the air flow paths of the cells more than that in the fuel gas flow paths.

The fuel cell system may also include a first pressure sensor working to measure a pressure of the air in the air supply line and a second pressure sensor working to measure a pressure of the air in the air drain line. When a difference between the pressures, as measured by the first and second pressure sensors, has decreased below that before the controller elevates the pressure of the air in the air flow path of each of the cells, the controller stops elevating the pressure of the air in the air flow path.

The fuel cell system may also include a current sensor working to measure an electric current generated in an area defined near an air outlet of the air flow path of at least one of the cells and a temperature sensor working to measure a temperature in the air outlet of the air flow path. The controller may determine whether the water exists in the air flow paths or not based on the electric current, as measured by the current sensor, and the temperature, as measured by the temperature sensor.

The fuel cell system may also include a cell voltage sensor working to measure the voltage, as developed by one of the cells. The controller may compare the voltage, as measured by the cell voltage sensor, with a given threshold value to determine whether the water exists in the air flow paths or not.

The fuel cell system may also include a total voltage sensor working to measure a total voltage, as generated by the cells. The controller may determine whether the water exists in the air flow paths or not based on the measured total voltage.

The fuel cell system may also include a humidifier working to humidify the fuel gas flowing through the fuel gas supply line into the fuel cell stack.

According to the third aspect of the invention, there is provided a fuel cell system which comprises: (a) a fuel cell stack made up of a plurality of cells each including a fuel gas flow path through which fuel gas flows and an air flow path through which air flows, each of the cells also including a fuel electrode exposed to the fuel gas flow path, an air electrode exposed to the air flow path, and an electrolyte disposed between the fuel electrode and the air electrode; (b) an evaporation controller working to increase an amount of water to be evaporated in the fuel gas flow paths of the cells above that in the air flow paths of the cells; and (c) a controller working to determine whether there is water in the air flow paths or not. When it is determined that the water exists in the air flow paths, the controller actuates the evaporation controller to increase the amount of water to be evaporated in the fuel gas flow paths above that in the air flow paths, thereby decreasing the amount of water on the surface of the electrolyte of each of the cells facing the fuel gas flow path below that facing the air flow path. This causes the water on the surface of the electrolyte facing the air flow path to transfer to that facing the fuel gas flow path through the electrolyte, thus minimizing the quantity of water to be evaporated and mixed with the air flowing in the air flow path to assure a desired concentration of oxygen in the air, thus resulting in the stability of operation of the fuel cell stack.

In the preferred mode of the invention, the evaporation controller may include a gas heater working to heat the fuel gas flowing through the fuel gas supply line. The controller actuates the gas heater to heat the fuel gas flowing through the fuel gas supply line to elevate a temperature in the fuel gas flow paths above that in the air flow paths, thereby increasing the amount of water to be evaporated in the fuel gas flow paths above that in the air flow paths.

The fuel cells system may also include a cell current determining circuit working to determine an electric current generated by the cells. The controller determines an amount of water having been produced in the cells based on the electric current, as determined by the cell current determining circuit, calculate a desired amount of water to be evaporated in the fuel gas flow paths based on the produced amount of water and an amount of water to be retained by the electrolytes of the cells, and determine a target temperature in the fuel gas flow paths needed to achieve evaporation of the desired amount of water. The controller actuates the gas heater to heat the fuel gas flowing through the fuel gas supply line so as to establish the target temperature in the fuel gas flow paths.

The evaporation controller may include a gas flow rate controller working to control a flow rate of the fuel gas flowing through the fuel gas supply line. The controller actuates the gas flow controller to increase an amount of the fuel gas supplied to the fuel cell stack, thereby increasing the amount of water to be evaporated in the fuel gas flow paths above that in the air flow paths.

The fuel cell system may also include a first pressure sensor working to measure a pressure of the air in the air supply line and a second pressure sensor working to measure a pressure of the air in the air drain line. When a difference between the pressures, as measured by the first and second pressure sensors, has decreased below that before the controller increases the amount of water to be evaporated in the fuel gas flow paths, the controller stops increasing the amount of water to be evaporated in the fuel gas flow paths.

The fuel cell system may also include a current sensor working to measure an electric current generated in an area defined near an air outlet of the air flow path of at least one of the cells and a temperature sensor working to measure a temperature in the air outlet of the air flow path. The controller may determine whether the water exists in the air flow paths or not based on the electric current, as measured by the current sensor, and the temperature, as measured by the temperature sensor.

The fuel cell system may also include a cell voltage sensor working to measure the voltage, as developed by one of the cells. The controller may compare the voltage, as measured by the cell voltage sensor, with a given threshold value to determine whether the water exists in the air flow paths or not.

The fuel cell system may also include a total voltage sensor working to measure a total voltage, as generated by the cells. The controller may determine whether the water exists in the air flow paths or not based on the measured total voltage.

The fuel cell system may also include a humidifier working to humidify the fuel gas flowing through the fuel gas supply line into the fuel cell stack.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram which shows a fuel cell system according to the first embodiment of the invention;

FIG. 2(a) is a perspective view which shows a fuel cell stack of the fuel cell system of FIG. 1;

FIG. 2(b) is an exploded perspective view which shows structures of separators of each of fuel cells making up the fuel cell stack of FIG. 2(a);

FIG. 3(a) is a plan view which shows one of the separators, as illustrated in FIG. 2(b), having a hydrogen flow path formed therein;

FIG. 3(b) is a plan view which shows one of the separators, as illustrated in FIG. 2(b), having an air flow path formed therein;

FIG. 4 is a flowchart of a program to be executed by the fuel cell system of FIG. 1 to keep electrolyte films of fuel cells in a desired wet condition;

FIG. 5 is a block diagram which shows a fuel cell system according to the second embodiment of the invention;

FIG. 6 is a block diagram which shows a fuel cell system according to the third embodiment of the invention;

FIG. 7 is a block diagram which shows a fuel cell system according to the fourth embodiment of the invention;

FIG. 8 is a plan view which shows the structure of a separator used in a fuel cell stack of the fuel cell system, as illustrated in FIG. 7;

FIG. 9 is a flowchart of a program to be executed by the fuel cell system of FIG. 7 to remove water from an air flow path of each fuel cell of a fuel cell stack;

FIG. 10 is a block diagram which shows a fuel cell system according to the fifth embodiment of the invention;

FIG. 11 is a block diagram which shows a fuel cell system according to the sixth embodiment of the invention;

FIG. 12 is a flowchart of a program to be executed by the fuel cell system of FIG. 11 to remove water from an air flow path of each fuel cell of a fuel cell stack; and

FIG. 13 is a flowchart of a sub-program, as performed in the program of FIG. 12, to control the amount of heating of hydrogen gas to be supplied to the fuel cell stack.

### DESCRIPTION OF THE PREFERRED EMBODIMENTS

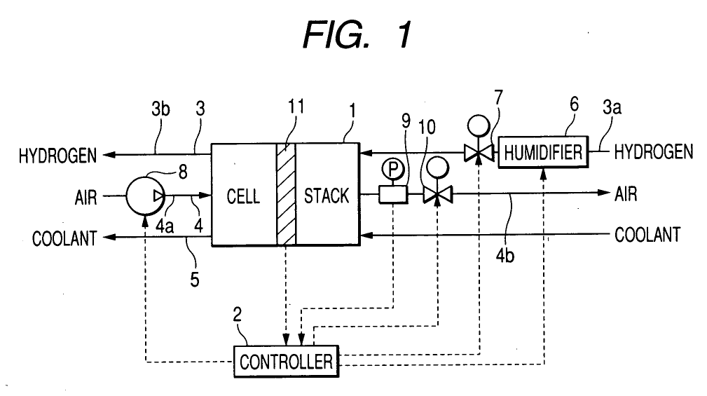

Referring to the drawings, wherein like reference numbers refer to like parts in several views, particularly to FIG. 1, there is shown a fuel cell system according to the first embodiment of the invention which is designed to increase the pressure of air in air flow paths extending in fuel cells higher than that when the fuel cells are operating normally, thereby keeping the fuel cells in desired operating conditions.

The fuel cell system consists essentially of a fuel cell stack 1, a controller (ECU) 2, a hydrogen path 3, an air path 4, and a coolant path 5. The fuel cell stack 1 is made up of, for example, a plurality of solid polymer electrolyte (proton exchange membrane) fuel cells, as will be described later in detail.

The hydrogen path 3 includes a hydrogen supply line 3a through which hydrogen gas is supplied to the fuel cell stack 1 and a hydrogen drain line 3b through which the hydrogen gas is drained out of the fuel cell stack 1.

The fuel cell system also includes a typical hydrogen supply device (not shown) which supplies the hydrogen gas to the fuel cell stack 1 through the hydrogen supply line 3a. In the hydrogen supply line 3a, a humidifier 6 and a hydrogen pressure regulator valve 7 are disposed. The humidifier 6 works to humidify the hydrogen gas flowing through the hydrogen supply line 3a. The hydrogen pressure regulator valve 7 works to regulate the pressure of the hydrogen gas flowing through the hydrogen supply line 3a. The humidifier 6 and the hydrogen pressure regulator valve 7 are controlled in operation by command signals outputted from the controller 2.

The air path 4 includes an air supply line 4a through which air is supplied to the fuel cell stack 1 and an air drain line 4b through which the air is drained out of the fuel cell stack 1.

The air supply line 4a connects with an air pump 8. The air pump 8 works to supply the air to the fuel cell stack 1 through the air supply line 4a. The air supply line 4a has no humidifier disposed therein.

In the air drain line 4b, an air pressure sensor 9 and an air pressure regulator valve 10 are disposed. The air pressure sensor 9 works to measure the pressure of air flowing through the air drain line 4b. The air pressure regulator valve 10 works to regulate the quantity or flow rate of air flowing through the air drain line 4b to regulate the pressure of air within the air drain line 4b.

The air pump 8 and the air pressure regulator valve 10 are controlled in operation by command signals outputted from the controller 2. The air pressure sensor 9 outputs a signal indicative of the pressure of air to the controller 2.

The coolant path 5 is a passage through which cooling water flows to cool the inside of the fuel cell stack 1. The coolant path 5 connects with a cooling system (not shown) which supplies the cooling water to the fuel cell stack 1.

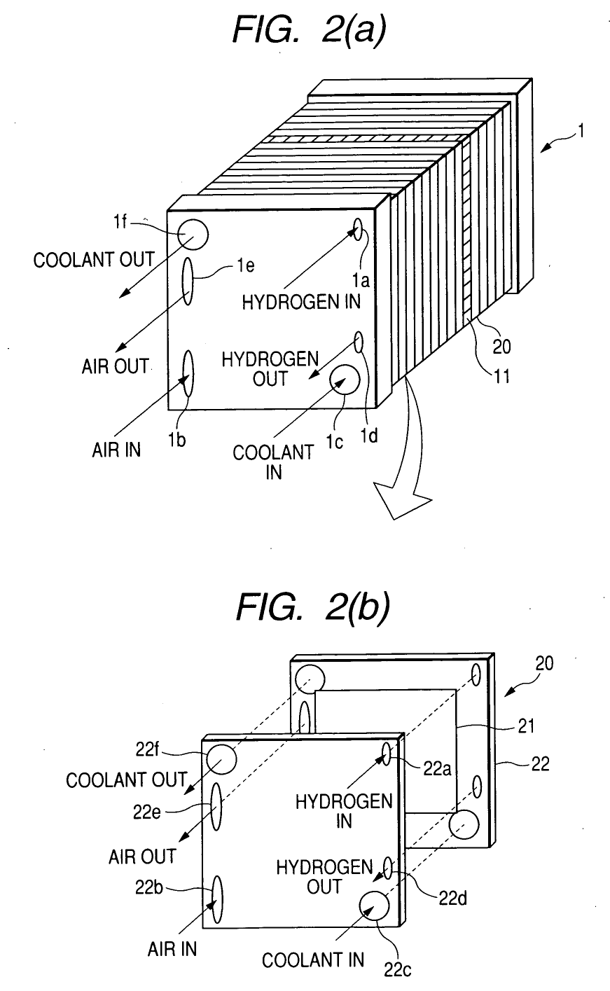

The fuel cell stack 1, as clearly shown in FIG. 2(a), has a plurality of fuel cells 20 laid to overlap each other in series electrically. The fuel cell stack 1 also formed in an end thereof a hydrogen inlet 1a, an air inlet 1b, and a coolant inlet 1c through which the hydrogen gas, the air, and the cooling water are inputted, respectively, a hydrogen outlet 1d, an air outlet 1e, and a coolant outlet 1f through which the hydrogen gas, the air, and the cooling water are drained, respectively.

The hydrogen supply line 3a, the air supply line 4a, the hydrogen drain line 3b, and the air drain line 4b are connected to the hydrogen inlet 1a, the air inlet 1b, the hydrogen outlet 1d, and the air outlet 1e, respectively. The coolant path 5 extends through the coolant inlet 1c and the coolant outlet 1f. Note that, in FIG. 1, the hydrogen supply line 3a, the air drain line 4b, and the coolant path 4 are shown to be joined to a right end of the fuel cell stack 1, while the hydrogen drain line 3b, the air supply line 4a, and the coolant path 4 are shown to be joined to a left end of the fuel cell stack 1 for the convenience of illustration.

Each of the cells 20 is, as clearly shown in FIG. 2(b), made up of an MEA (Membrane Electrode Assembly) 21 and separators 22 affixed to ends of the MEA 21.

Each of the separators 22 is made of a gas non-permeable conductive material such as carbon and has formed therein a hydrogen inlet 22a, an air inlet 22b, and a coolant inlet 22c through which the hydrogen gas, the air, and the coolant enter the cell 20 and a hydrogen outlet 22d, an air outlet 22e, and a coolant outlet 22f through which the hydrogen gas, the air, and the coolant are drained out of the cell 20.

The hydrogen inlet 22a is located closer to the air outlet 22e than the hydrogen outlet 22d. The hydrogen outlet 22d is located closer to the air inlet 22b than the hydrogen inlet 22a.

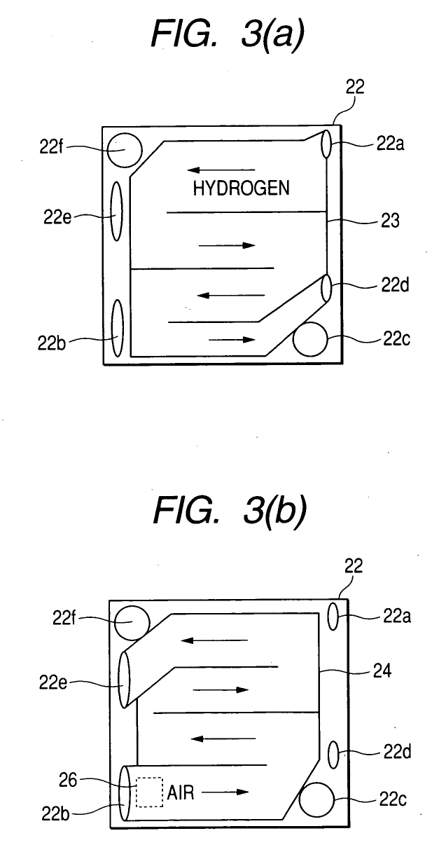

Each of the separators 22 has a fuel electrode-exposed surface facing a fuel electrode of the MEA 21 and an air electrode-exposed surface facing an air electrode of the MEA 21. The fuel electrode-exposed surface, as clearly shown in FIG. 3(a), has formed therein a wave-shaped groove defining a hydrogen flow path 23 which extends from the hydrogen inlet 22a to the hydrogen outlet 22d. The air electrode-exposed surface, as clearly shown in FIG. 3(b), has formed therein a wave-shaped groove defining an air flow path 24 which extends from the air inlet 22b to the air outlet 22e.

Each of the separators 22 also has a coolant flow path (not shown) extending inside the separator 22.

The hydrogen gas flowing from the hydrogen supply line 3a enters inside the fuel cell stack 1 at the hydrogen inlet 1a, travels through the hydrogen flow paths 23 from the hydrogen inlets 22a to the hydrogen outlets 22d of the cells 20 sequentially, and goes out of the hydrogen outlet id of the fuel cell stack 1 into the hydrogen drain line 3b.

The air flowing from the air supply line 4a enters inside the fuel cell stack 1 at the air inlet 1b, travels through the air flow paths 24 from the air inlets 22b to the air outlets 22e of the cells 20 sequentially, and goes out of the air outlet 1e of the fuel cell stack 1 into the air drain line 4b.

The cooling water flowing within the coolant path 5 enters inside the fuel cell stack 1 at the coolant inlet 1c, travels through the cells 20 from the coolant inlets 22c to the coolant outlets 22f sequentially, and goes out of the coolant outlet if of the fuel cell stack 1 into the coolant path 5.

The MEA 21 of each of the cells 20 consists of an electrolyte film made of a proton conductive ion-exchange membrane and a pair of electrodes affixed to the electrolyte film. Each of the electrodes includes a catalyst layer and a gas-diffusion layer. One of the electrodes, as described above, serves as the air electrode (i.e., positive electrode) exposed to the air (i.e., oxidant gas also called cathode gas). The other electrode serves as the fuel electrode (i.e., negative electrode) exposed to the hydrogen gas (i.e., fuel gas also called anode gas).

In operation of the fuel cell stack 1, each of the cell 20 works to convert energy, as produced by electrochemical reactions of the oxygen-containing air supplied to the air electrode and the hydrogen gas supplied to the fuel electrode, into electric power. The water is also produced at the air electrode. The electrochemical reactions are of the forms:
Fuel electrode H₂→2H⁺+2e⁻
Air electrode 2H⁺+1/20₂+2e⁻→H₂O

The fuel cell stack 1 also includes, as shown in FIGS. 1 and 2(a), a current sensor plate 11 which is disposed between central adjacent two of the cells 20. The current sensor plate 11 works to measure an electric current (or local current) generated in a specified area 26, as illustrated in FIG. 3(b), defined near the air inlet 22b on the surface of one of the cells 20. The current sensor plate 11 may also be designed to measure the current, as generated in the areas 26 of some of the cells 20.

The current sensor plate 11 is made of, for example, a conductive material and made up of a conductive portion and a sensing element. The conductive portion is disposed between the cells 20 in electric connection therewith. The sensing element works to measure the current flowing through the conductive portion and outputs a signal indicative thereof to the controller 2. An additional one or some current sensor plates identical in structure of the current sensor plates 11 may also be installed in the fuel cell stack 1. For instance, they may be disposed either or both of the right and left sides of the current sensor plate 11, as illustrated in FIG. 1.

The controller 2, as can be seen in FIG. 1, works to output command signals to control operations of the humidifier 6, the hydrogen pressure regulator valve 7, the air pump 8, and the air pressure regulator valve 10. The controller 2 also receives outputs from the air pressure sensor 9 and the current sensor plate 11.

The controller 2 also works to perform an electrolyte wet-keeping operation, as will be described later in detail, and is equipped with a storage memory storing a current threshold, as will be referred to later. The controller 2 may be implemented by a typical microcomputer made up of a CPU, a ROM, and a RAM and a peripheral circuit.

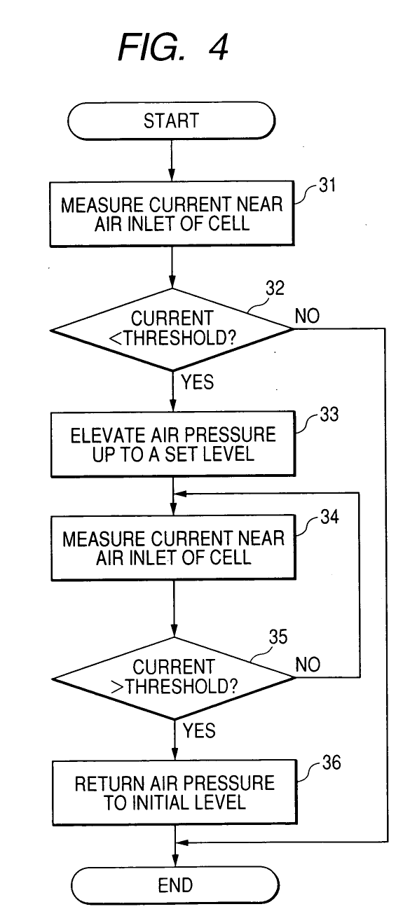

FIG. 4 is a flowchart of an electrolyte wet-keeping program to be executed by the controller 2. This program is initiated upon start of operation of the fuel cell stack 1 and carried out cyclically.

When turned on, the fuel cell system actuates the hydrogen supply device and the air pump 8 to supply the hydrogen gas and the air to the fuel cell stack 1 to start the electricity-generating operation. Simultaneously, the controller 2 turns on the humidifier 6 to humidify the hydrogen gas flowing through the hydrogen supply line 3a. The air flowing through the air supply line 4a is not humidified.

The current sensor plate 11 measures the current generated in the area 26 of the cell 20 near the air inlet 22b and outputs a signal indicative thereof to the controller 2.

First, in step 31, the controller 2 monitors or samples the output from the current sensor plate 11 to determine the current generated in the area 26 of the cell 20.

The routine proceeds to step 32 wherein it is determined whether the current, as determined in step 31, is smaller than a threshold value, as stored in the memory of the controller 2, or not. Usually, when the electrolyte film of the cell 20 is being dried, it results in a drop in output of the cell 20. Based on this fact, step 32 monitors the magnitude of current generated in the area 26 near the air inlet 22b of the cell 20 to determine whether the area 26 is getting dried or not. In the case where the plurality of current sensor plates 11 are installed in the fuel cell stack 1, step 32 compares each of outputs from the current sensor plates 11 with the threshold value. When at least one of the outputs is smaller than the threshold value, a YES answer is obtained.

The threshold value, as used in step 32, may be, for example, 0.5 A/cm² selected from an I-V map, as prepared in advance when the fuel cell stack 1 is operating normally and when the cell 20 is dried.

If a YES answer is obtained in step 32 meaning that the current, as measured in step 31, is smaller than the threshold value, that is, that the cell 20 is getting dried, then the routine proceeds to step 33. Alternatively, if a NO answer is obtained, then the routine terminates.

In step 33, the controller 2 monitors an output from the air pressure sensor 9 and outputs the command signal to the air pressure regulator valve 10 to elevate the pressure in the air flowing through the air drain line 4b up to a set level quickly. The set level is selected to be higher than the pressure of the air when the fuel cell stack 1 is operating normally and lower than the pressure the fuel cell stack 1 withstands. The normal operation of the fuel cell stack 1 represents a steady operation thereof in which the fuel cell stack 1 is producing a desired level of electric power. The pressure the fuel cell stack 1 withstands is a maximum pressure not leading to leakage of gas from seals such as gaskets in the fuel cell stack 1.

The pressure in the air drain line 4b when the fuel cell stack 1 is operating normally is approximately 50 kPa. The set level may be, for example, 150 kPa.

After step 33, the routine proceeds to step 34 wherein the controller 2 samples the output from the current sensor plate 11 to determine the current generated in the area 26 of the cell 20 again.

The routine proceeds to step 35 wherein it is determined whether the current, as determined in step 33, is greater than a threshold value, as stored in the memory of the controller 2, or not. This determination is made to determine whether the electrolyte film of the cell 20 has get wet near the air inlet 22b or not based on the fact that when the electrolyte film is dried, it will result in an increase in electric resistance thereof, thus leading to a decrease in electricity generated by the cell 20, while when the electrolyte film returns to a wet condition, it will result in an increase in electricity generated by the cell 20. In the case where the plurality of current sensor plates 11 are installed in the fuel cell stack 1, step 35 compares each of outputs from the current sensor plates 11 with the threshold value. When at least one of the outputs is greater than the threshold value, a YES answer is obtained.

The threshold value, as used in step 35, may be the same as in step 32 or set to another value (e.g., 1.0 A/cm²).

If a YES answer is obtained in step 35 meaning that the current now being generated is greater than the threshold value, that is, that the electrolyte film of the cell 20 is placed in a desired wet condition, then the routine proceeds to step 36. Alternatively, if a NO answer is obtained, then the routine returns back to step 34.

In step 36, the controller 2 controls the air pressure regulator valve 10 to lower the pressure of the air in the air drain line 4b to the initial level (i.e., the level before step 33).

The features of the fuel cell system of this embodiment will be described below.

The controller 2 is designed to determine in step 32 whether the current, as generated in the area 26 near the air inlet 22b of the cell 20, is smaller than the threshold value or not, that is, whether the electrolyte film of the cell 20 is getting dried or not. When it is determined that the electrolyte film is getting dried, the controller 2 increases the pressure of the air in the air drain line 4b above that when the fuel cell stack 1 is operating normally to increase the pressure of the air in the air flow paths 24 of the cells 20. This results in a decreased velocity of flow of the air in the air flow path 24 of each of the cells 20 to increase the concentration of oxygen on the side of the air inlet 22b, thereby increasing the electrochemical reactions in the area 26, which will lead to production of a great amount of water which diffuses on the electrolyte film to moisten it.

Specifically, when the non-humidified air is supplied to the fuel cell stack 1, and the electrolyte film of each of the cells 20 is placed in an easy-to-dry condition, especially at the start of operation of the fuel cell stack 1, the fuel cell system works to avoid drying of the electrolyte film, thereby ensuring the stability of operation of the fuel cell stack 1.

We performed tests to evaluate the improvement of efficiency of power generation of the fuel cell system and found that it is improved by 4% as compared with when humidified air is supplied to the fuel cell stack 1 and by 2.7% as compared with when non-humidified air is supplied to the fuel cell stack 1 without controlling the wet condition of the cells 20 in the manner as described above.

The fuel cell system of this embodiment, as described above, has no humidifier to moisten the air to be supplied to the fuel cell stack 1, thus permitting the size thereof to be decreased.

Step 35 compares, as described above, the output of the current sensor plate 11 with the threshold value to determine whether the amount of electricity generated by the cell 20 has increased or not, but it may be made using the rate of increase in current for a given period of time, as found by monitoring a change in the output from the current sensor plate 11.

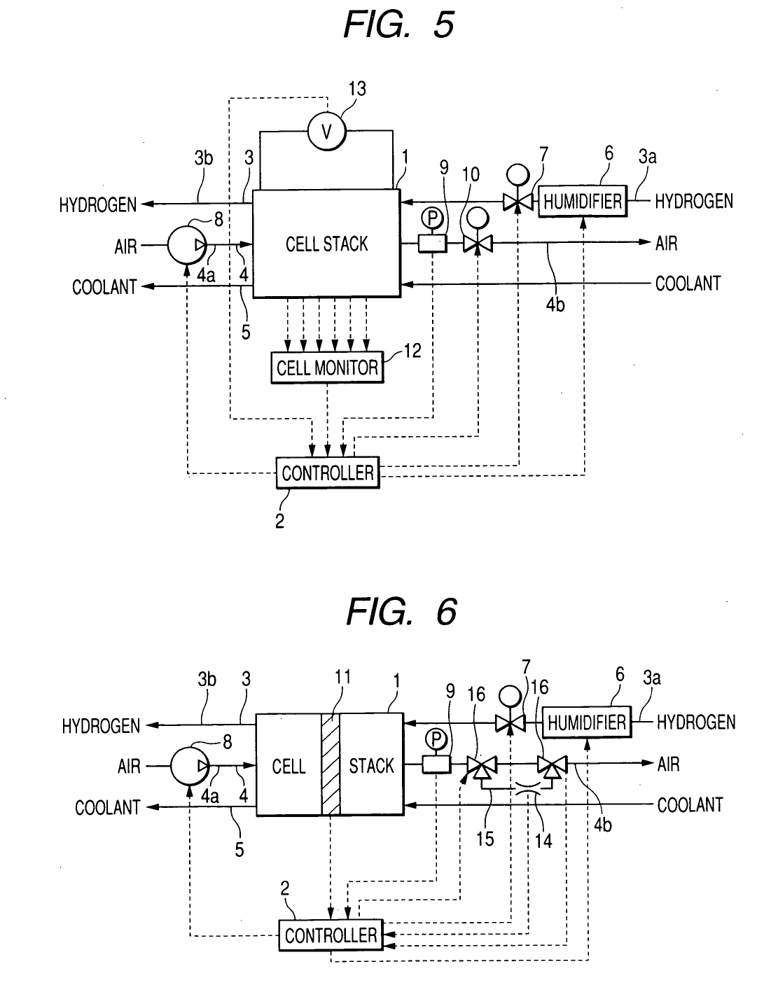

FIG. 5 shows a fuel cell system according to the second embodiment of the invention. The same reference numbers as employed in the first embodiment refers to the same parts, and explanation thereof in detail will be omitted here.

The controller 2 is, as will be described later in detail, designed to monitor voltages developed by the cells 20, the total voltage developed by the fuel cell stack 1, or impedances of the cells 20 to determine whether the cells 20 are being dried or not.

The fuel cell system includes a cell monitor 12 which monitors or measures the voltage appearing at each of the cells 20 and outputs a signal indicative thereof to the controller 2. The cell monitor 12 may be designed to measure voltages, as produced only by some of the cells 20.

The controller 2 is designed to perform a program that is similar to the one of FIG. 4 except as described below.

First, in step 31, the controller 2 samples outputs from the cell monitor 12 which indicate the voltages developed by the cells 20, respectively.

The routine proceeds to step 32 wherein it is determined whether each of the voltages, as sampled in step 31, is smaller than a threshold value, as stored in the memory of the controller 2, or not. Usually, when the electrolyte film of each of the cells 20 is being dried near the air inlet 22b, it causes an I-V relation of the cells 20 to be different from that when the electrolyte film is wet sufficiently. Specifically, when the electrolyte film of the cell 20 is dried on the side of the air inlet 22b, it results in an increase in electric resistance of the electrolyte film, thus leading to a drop in voltage of the cell 20. Based on this fact, step 32 monitors the level of voltage of each of the cells 20 to determine whether an area of the electrolyte film near the air inlet 22b is getting dried or not.

The threshold value, as used in step 32, may be selected from an I-V map, as prepared in advance when the fuel cell stack 1 is operating normally and when the cell 20 is dried.

If a YES answer is obtained in step 32 meaning that at least one of the voltages of the cells 20 is smaller than the threshold value, then the routine proceeds to step 33. Alternatively, if a NO answer is obtained meaning that the voltages of all of the cells 20 are greater than the threshold value, then the routine terminates. Step 33 is identical in operation with that in the first embodiment, and explanation thereof in detail will be omitted here.

The routine proceeds to step 34 wherein the controller 2 samples the outputs from the cell monitor 12 again.

The routine proceeds to step 35 wherein it is determined whether all the voltages, as sampled in step 34, are greater than a threshold value, as stored in the memory of the controller 2, or not.

If a YES answer is obtained in step 35, then the routine proceeds to step 36. Alternatively, if a NO answer is obtained, then the routine returns back to step 34.

The fuel cell system may also include, as shown in FIG. 5, a voltage sensor 13 which works to measure a total voltage appearing across the fuel cell stack 1 and output a signal indicative thereof to the controller 2.

The controller 2, like the above, performs a program similar to the one of FIG. 4 except as described below.

First, in step 31, the controller 2 samples an output from the voltage sensor 13 which indicate the total voltage developed across the fuel cell stack 1.

The routine proceeds to step 32 wherein it is determined whether the voltage, as sampled in step 31, is smaller than a threshold value, as stored in the memory of the controller 2, or not. Usually, the electrolyte films of all of the cells 20 are dried near the air inlets 22b simultaneously, which results in a drop in voltage appearing across the fuel cell stack 1. Based on this fact, step 32 samples the level of the voltage of the fuel cell stack 1 to determine whether an area of the electrolyte film near the air inlet 22b of each of the cells 20 is getting dried or not.

If a YES answer is obtained in step 32, then the routine proceeds to step 33. Alternatively, if a NO answer is obtained, then the routine terminates. Step 33 is identical in operation with that in the first embodiment, and explanation thereof in detail will be omitted here.

The routine proceeds to step 34 wherein the controller 2 samples the output from the voltage sensor 13 again.

The routine proceeds to step 35 wherein it is determined whether the voltage, as sampled in step 34, is greater than a threshold value, as stored in the memory of the controller 2, or not.

If a YES answer is obtained in step 35, then the routine proceeds to step 36. Alternatively, if a NO answer is obtained, then the routine returns back to step 34.

The fuel cell system may be equipped with an impedance monitor (not shown) instead of the cell monitor 12. The impedance monitor works to measure the impedance of each of the cells 20 near the air inlets 22b and outputs a signal indicative thereof to the controller 2. The impedance monitor may be designed to measure impedances of some of the cells 20.

Usually, when the electrolyte film of each of the cells 20 is dried, it will result in an increase in impedance of the cells 20. For instance, when the electrolyte film is in the wet condition, the impedance is 10 mΩ. When the electrolyte film is in the dry condition, the impedance is 100 mΩ.

The controller 2 works to perform the above described program using outputs of the impedance monitor in place of the outputs of the cell monitor 12.

FIG. 6 shows a fuel cell system according to the third embodiment of the invention. The same reference numbers as employed in the first embodiment refers to the same parts, and explanation thereof in detail will be omitted here.

The fuel cell system includes selector valves (also called directional control valves) 16 and a choke or throttle 14 instead of the air pressure regulator valve 10 as used in the first embodiment. The selector valves 16 are disposed in series in the air drain line 4b and controlled in operation by the controller 2. A bypass line 15 extends in parallel to the air drain line 4b between the selector valves 16. The throttle 14 is disposed in the bypass line 15 to decrease the flow rate of the air flowing through the bypass line 15 The throttle 14 may be implemented by an orifice.

The controller 2 is designed to perform the same program as in FIG. 4. When it is required in step 33 to elevate the pressure of the air in the air drain line 4b, the controller 2 actuates the selector valves 16 to block a portion of the air drain line 4b between the selector valves 16 and direct the air to the bypass line 15 in which the throttle 14 is installed. The throttle 14 works to decrease the flow rate of the air passing therethrough to a constant value, thereby resulting in elevation in the pressure of the air flowing through the air flow path 24 of each of the cells 20.

Other arrangements are identical with those in the first embodiment, and explanation thereof in detail will be omitted here.

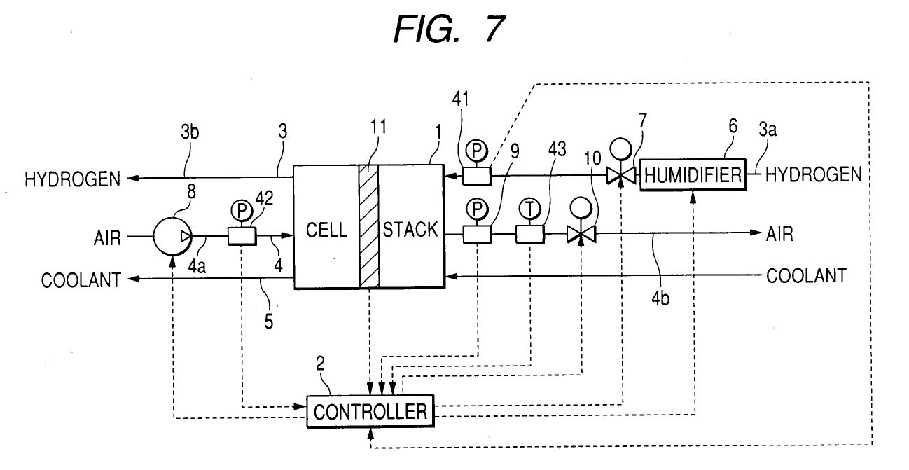

FIG. 7 shows a fuel cell system according to the fourth embodiment of the invention. The same reference numbers as employed in the first embodiment refers to the same parts, and explanation thereof in detail will be omitted here.

The fuel cell system is engineered to elevate the pressure in the air flow paths 24 of the cells 20 above that in the hydrogen flow paths 23 when the water, as produced by the chemical reaction, exists in the air flow paths 24 of the cells 20.

The fuel cell system includes a hydrogen gas pressure sensor 41, an air pressure sensor 42, and a temperature sensor 43. The hydrogen gas pressure sensor 41 is disposed in the hydrogen supply line 3a and works to measure the pressure of the hydrogen gas flowing through the hydrogen supply line 3a to output a signal indicative thereof to the controller 2. The air pressure sensor 42 is disposed in the air supply line 4a and works to measure the pressure of the air flowing through the air supply line 4a to output a signal indicative thereof to the controller 2. The temperature sensor 43 works to measure the temperature of the air in the air drain line 4b and output a signal indicative thereof to the controller 2.

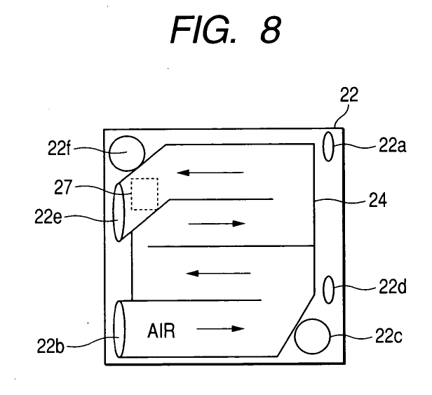

The fuel cells system also includes the current sensor plate 11 which is designed, unlike the first embodiment, to measure the current produced, as illustrated in FIG. 8, in an area 27 defined near the air outlet 22e of the air flow path 24 formed in the separator 22 of the cell 20.

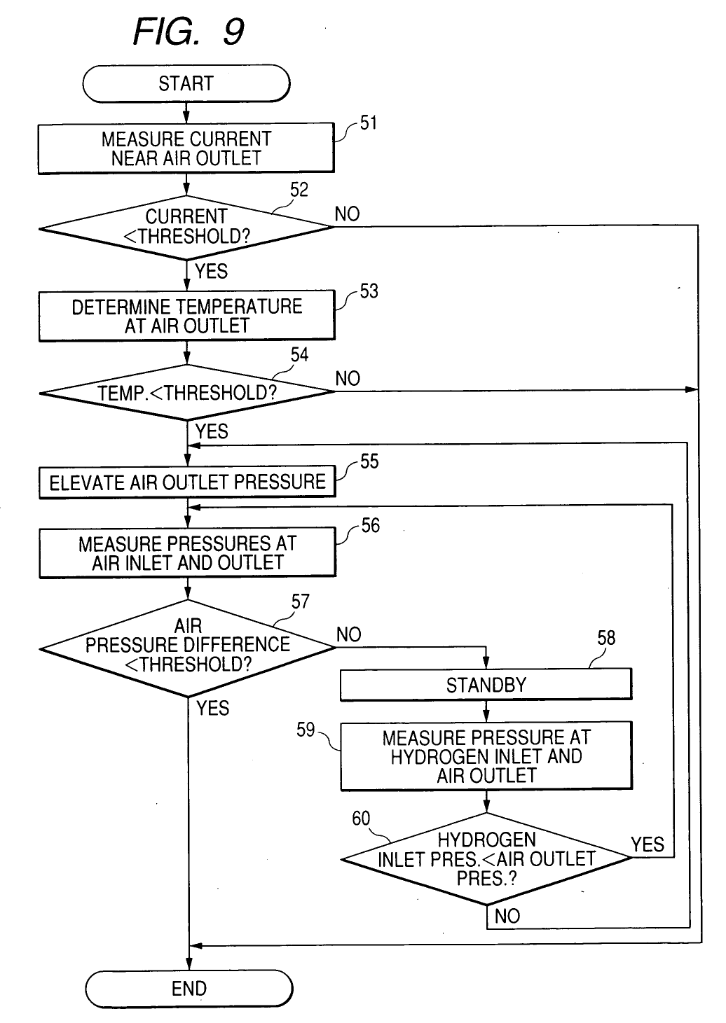

The controller 2 works to execute a water-removing program, as illustrated in FIG. 9, to remove the water, as produced in the air flow paths 24 of the cells 20.

The water-removing program is initiated upon start of operation of the fuel cell stack 1 and carried out at given intervals.

When turned on, the fuel cell system actuates the hydrogen supply device and the air pump 8 to supply the hydrogen gas and the air to the fuel cell stack 1 to start the electricity-generating operation. Simultaneously, the controller 2 outputs the command signal to the humidifier 6 to humidify the hydrogen gas flowing through the hydrogen supply line 3a. The air flowing through the air supply line 4a is not humidified.

The current sensor plate 11 measures the current generated in the area 27 of the cell 20 near the air outlet 22e and outputs a signal indicative thereof to the controller 2.

First, in step 51, the controller 2 samples the output from the current sensor plate 11 to determine the current generated in the area 27 of the cell 20.

The routine proceeds to step 52 wherein it is determined whether the current, as sampled in step 51, is smaller than a threshold value, as stored in the memory of the controller 2, or not to determine whether the water exists in the air flow path 24 of the cell 20 or not.

Usually, when a great amount of water exists around the air outlet 22e of the cell 20, it will disturb the diffusion of the water on the electrolyte film of the cell 20, thereby resulting in a decrease in amount of electricity generated by the cell 20. The water in the air flow path 24 usually flows toward the air outlet 22e, so that the largest amount of water will exist around the air outlet 22e of the air flow path 24. Based on this fact, step 52 samples the level of current generated in the area 27 near the air outlet 22e of the cell 20 to determine whether the water is present around the air outlet 22e or not.

If a YES answer is obtained in step 52 meaning that the current, as sampled in step 51, is smaller than the threshold value, that is, that the water exists around the air outlet 22e to disturb the power generation of the cell 22, then the routine proceeds to step 53. Alternatively, if a NO answer is obtained, then the routine terminates.

In step 53, the controller 2 samples an output from the temperature sensor 43 installed in the air drain line 4b.

The routine proceeds to step 54 wherein it is determined whether the temperature, as sampled in step 53, is smaller than a threshold value, as stored in the memory of the controller 2, or not to determine whether the water exists within the air flow path 24 of the cell 20 or not.

Usually, when the temperature is lower near the air outlet 22e of the air flow path 24 of the cell 20, it will facilitate ease of condensation (i.e., liquefaction) of water vapor to produce water in the air flow path 24. Based on this fact, the controller 2 analyzes the temperature in the air drain line 4b to determine whether the temperature near the air outlet 22e of the air flow path 24 of the cell 20 is the temperature which will induce the condensation of water vapor or not. When it is determined that the temperature near the air outlet 22e has dropped to the level causing the condensation of water vapor, the controller 2 determines that the amount of water which will disturb the power generation exits near the air outlet 22e of the air flow path 24 of the cell 20.

If a NO answer is obtained in step 54 meaning that the water does not exist in the air flow path 24, then the routine terminates. Alternatively, if a YES answer is obtained, then the routine proceeds to step 55 wherein the controller 2 samples outputs from the air pressure sensor 9 installed in the air drain line 4b and the hydrogen gas pressure sensor 41 installed in the hydrogen supply line 3a and controls the air pressure regulator valve 10 to elevate the pressure of the air flowing through the air drain line 4b up to a set level so as to keep a difference between the pressure of the air in the air drain line 4b and the pressure of the hydrogen gas in the hydrogen supply line 3a within a given pressure range.

The pressure range is, for example, 5 kPa or more that is a pressure difference between the air in the air drain line 4b and the hydrogen gas in the hydrogen supply line 3a which will cause the water existing on the side of the air electrode of each of the cells 20 to travel through the electrolyte film to the fuel electrode.

After step 55, the routine proceeds to step 56 wherein the controller 2 samples outputs from the air pressure sensor 42 installed in the air supply line 4a and the air pressure sensor 9 installed in the air drain line 4b.

The routine proceeds to step 57 wherein it is determined whether a difference between the outputs, as sampled in step 56, that is, a difference in pressure of the air between the air supply line 4a and the air drain line 4b that is equivalent to a pressure difference between the air inlet 22b and the air outlet 22e of the air flow path 24 of the cell 20 has decreased below that before the pressure of the air in the air drain line 4b is elevated in step 55 or not. The pressure difference before execution of step 55 is determined by sampling outputs from the air pressure sensors 9 and 42 before step 55 and stored as a threshold value indicating the pressure difference between the air inlet 22b and the air outlet 22e of the air flow path 24.

Usually, when the water exists around the air outlet 22e of the air flow path 24, it will result in a drop in pressure of the air flowing through the air flow path 24. Based on this fact, the controller 2 analyzes the difference in pressure of the air between the air supply line 4a and the air drain line 4b (i.e., the pressure difference between the air inlet 22b and the air outlet 22e of the air flow path 24) to determine whether the water has traveled through the electrolyte film from the air flow path 24 to the hydrogen flow path 23 of the cell 20 or not.

If a YES answer is obtained in step 57 meaning that the pressure difference between the air inlet 22b and the air outlet 22e of the air flow path 24 has decreased, so that the water has disappeared from the air flow path 24 of the cell 20, then the routine terminates. Alternatively, if NO answer is obtained, then the routine proceeds to step 58 and stays for a given period of time.

After the elapse of the given period of time in step 58, the routine proceeds to step 59 wherein the controller 2 samples outputs from the air pressure sensor 9 installed in the air drain line 4b and the hydrogen gas pressure sensor 41 installed in the hydrogen supply line 3a. The routine proceeds to step 60 wherein it is determined whether the pressure of the air in the air drain line 4b is greater than the pressure of the hydrogen gas in the hydrogen supply line 3a or not to determine whether the difference between the pressure of the air in the air drain line 4b and the pressure of the hydrogen gas in the hydrogen supply line 3a lies within the given pressure range or not.

If a YES answer is obtained meaning that the pressure of the air in the air drain line 4b is greater than the pressure of the hydrogen gas in the hydrogen supply line 3a, then the routine returns back to step 56. Alternatively, if a NO answer is obtained, then the routine returns back to step 55 to elevate the pressure of the air flowing through the air drain line 4b.

The features of the fuel cell system of this embodiment will be described below.

The controller 2 is designed to determine in step 52 whether the current, as generated in the area 27 near the air outlet 22e of the cell 20, is smaller than the threshold value or not, that is, whether an undesirable amount of water exists near the air outlet 22e of the air flow path 24 of the cell 20 or not. If YES answers are obtained both in steps 52 and 54, the controller 2 actuates the air pressure regulator valve 10 to increases the pressure of the air in the air drain line 4b above the pressure of the hydrogen gas in the hydrogen supply line 3a.

Usually, when much water has been produced on the side of the air electrode of each of the cells 20, it flows to the air outlet 22e of the air flow path 24, so that a large amount of water stays around the air outlet 22e. The controller 2 analyzes whether the water exits near the air outlet 22e of the air flow path 24 of the cell 20 or not to determine whether the water exists in the air flow path 24. When it is determined that the water exits in the air flow path 24, the controller 2 elevates the pressure in the air flow path 24 of each of the cells 20 above that in the hydrogen flow path 23 to transfer the water, as produced by the power generation of the fuel cell stack 1, from the air flow path 24 to the hydrogen flow path 23 through the electrolyte film of each of the cells 20. This prevents the water present near the air outlet 22e of the air flow path 24 from vaporizing and mixing with the air flowing through the air flow path 24, thereby avoiding a drop in apparent concentration of oxygen contained in the whole of air in the fuel cell stack 1 arising from the water vapor contained in the flow of air.

The fuel cell system of this embodiment may be modified as described below.

The increasing the pressure of air in the air drain line 4b above that of the hydrogen gas in the hydrogen supply line 3a is achieved only using the air pressure regulator valve 10 disposed in the air drain line 4b, however, it may be made by actuating the hydrogen pressure regulator valve 7 to lower the pressure of the hydrogen gas in the hydrogen supply line 3.

Each of the cells 20 has, as described above, the hydrogen inlet 22a disposed closer to the air outlet 22e than the air inlet 22b. The transferring of the water from the air flow path 24 to the hydrogen flow path 23 of each of the cells 20 is, therefore, achieved by increasing the pressure of air in the air drain line 4b leading to the air outlet 22e above that of the hydrogen gas in the hydrogen supply line 3a leading to the hydrogen inlet 22a. The hydrogen outlet 22d may alternatively be disposed closer to the air outlet 22e than the air inlet 22b. In this case, the transferring of the water from the air flow path 24 to the hydrogen flow path 23 is achieved by increasing the pressure of air in the air drain line 4b leading to the air outlet 22e above that of the hydrogen gas in the hydrogen drain line 3b leading to the hydrogen outlet 22d to elevate the pressure in the air flow path 24 more than that in the hydrogen flow path 23. Such increasing of the pressure in air in the air drain line 4b may be accomplished using the air pressure regulator valve 10 or by installing a hydrogen pressure regulator valve in the hydrogen drain line 3b to lower the pressure of the hydrogen gas.

The controller 2 is, as described above, designed to determine in step 52 whether the current, as sampled from the area 27 close to the air outlet 22e of the cell 20, is smaller than the threshold value or not and also determine in step 54 whether the temperature in the air drain line 4b is smaller than the threshold value or not to determine whether the water exists within the air flow path 24 of the cell 20 or not, however, determinations may alternatively be made in steps 52 and 54 as to whether an operating condition of the fuel cell stack 1 is met or not which will produce a large amount of water and may be given in advance by a relation between current density of the cells 20 and the temperature in the fuel cell stack 1. For instance, the controller 2 may determine in step 52 whether the current, as sampled from the cell 20, is 0.7 A/cm² or not and determine in step 54 whether the temperature in the fuel cell stack 1 is 60° C. or not. The current density of the cell 20 may be measured using the current sensor plate 11. The temperature in the fuel cell stack 1 may be measured by installing a typical temperature sensor (not shown) in the fuel cell stack 1.

The controller 2 may alternatively monitor the current, as sampled from the current sensor plate 11, for a given period of time and determine in step 52 whether the current is oscillating with time or not to determine whether the water exists within the air flow path 24 of the cell 20 or not. This is based on the fact that the water present around the air electrode of the cell 20 will result in a time-sequential variation in amount of electricity generated by the cell 20.

The sensor plate 11 is, as illustrated in FIG. 8, designed to measure the current in the area 27 near the air outlet 22e of the cell 20, however, may alternatively sample it, like the first embodiment, from the area 26, as illustrated in FIG. 3, defined near the air inlet 22b. In this case, the controller 2 executes the water-removing program of FIG. 9 which is modified, as described below.

In step 51, the controller 2 samples the current generated in the area 26 near the air inlet 22b of the cell 20 from the current sensor plate 11.

In step 52, the controller 2 determines whether the sampled current is greater than a threshold value, as stored in the memory, or not. The threshold value is different from that used in the above embodiment. Usually, generation of a larger amount of current in the area 26 will result in production of a larger amount of water. When the air flowing through the air flow path 24 of the cell 20 is lower in temperature, the pressure of saturated vapor will be low, thus causing much water to be produced in the air flow path 24. The determination of whether an unwanted amount of water exists around the air outlet 22e of the cell 20 or not may, thus, be achieved by steps 52 and 54.

Instead of the air pressure regulator valve 10, the throttle 14, as described in the third embodiment, may alternatively be used to regulate the difference between the pressure of the air in the air drain line 4b and the pressure of the hydrogen gas in the hydrogen supply line 3a.

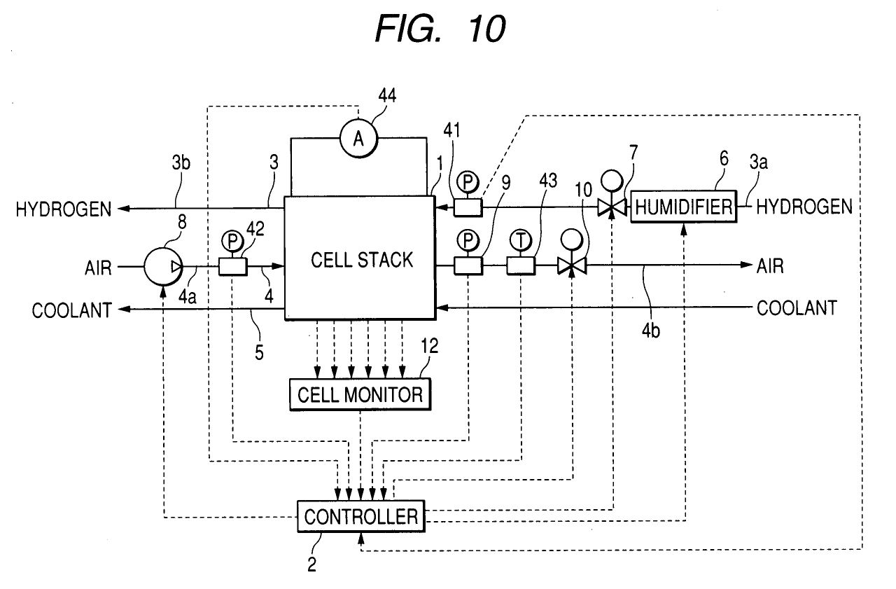

FIG. 10 shows a fuel cell system according to the fifth embodiment of the invention which is a modification of the fourth embodiment, as illustrated in FIG. 7. The same reference numbers as employed in the fourth embodiment refers to the same parts, and explanation thereof in detail will be omitted here.

The controller 2 of the fuel cell system of the fourth embodiment, as described above, works to elevate the pressure of the air in the air flow path 24 above that of the hydrogen gas in the hydrogen flow path 23 of each of the cells 20 to transfer the water from the air flow path 24 to the hydrogen flow path 23, but it is designed in this embodiment to make a determination of whether the pressure of the air in the air flow path 24 should be elevated or not based on the voltage appearing at each of the cells 20 or the total voltage developed across the fuel cell stack 1.

The fuel cell system includes a current sensor 44 which measures a total current, as produced by all of the cells 20 of the fuel cell stack 1, and outputs a signal indicative thereof to the controller 2.

The controller 2 is designed to perform a water-removing program that is similar to the one of FIG. 9 except as described below.

First, in step 51, the controller 2 samples an output from the current sensor 44 to determine a total current, as produced by the fuel cell stack 1.

The routine proceeds to step 52 wherein it is determined whether the current, as sampled in step 51, is smaller than a threshold value, as stored in the memory of the controller 2, or not to determine whether the water has been produced in the air flow path 24 of the cells 20 or not.

Usually, when there is water in the air flow path 24 of the cell 20, it will disturb the diffusion of the water on the electrolyte film of the cell 20, thereby resulting in a decrease in amount of electricity generated by the cell 20. The water usually exits in all the cells 20 simultaneously, thus resulting in a decrease in total amount of current produced by the fuel cell stack 1. Based on this fact, step 52 samples the level of current, as measured by the current sensor 44, to determine whether the water exist in the air flow paths 24 of the cells 20 or not.

The controller 2 may alternatively monitor the current, as sampled from the current sensor 44, for a given period of time and determine in step 52 whether the current is oscillating with time or not to determine whether the water exists within the air flow path 24 of the cell 20 or not. This is, as described above, based on the fact that the water present around the air electrode of the cell 20 will result in a time-sequential variation in amount of current generated by the cell 20.

The fuel cell system may also include the cell monitor 12 which monitors or measures the voltage appearing at each of the cells 20 and outputs a signal indicative thereof to the controller 2. The cell monitor 12 may be designed to measure voltages, as produced only by some of the cells 20.

The controller 2 may sample an output from the cell monitor 12 in step 51 and determine in step 52 whether the current, as sampled in step 51, is smaller than a threshold value, as stored in the memory of the controller 2, or not to determine whether the water exists in the air flow path 24 of the cells 20 or not.

Following steps are identical in operation with the ones in FIG. 9, and explanation thereof in detail will be omitted here.

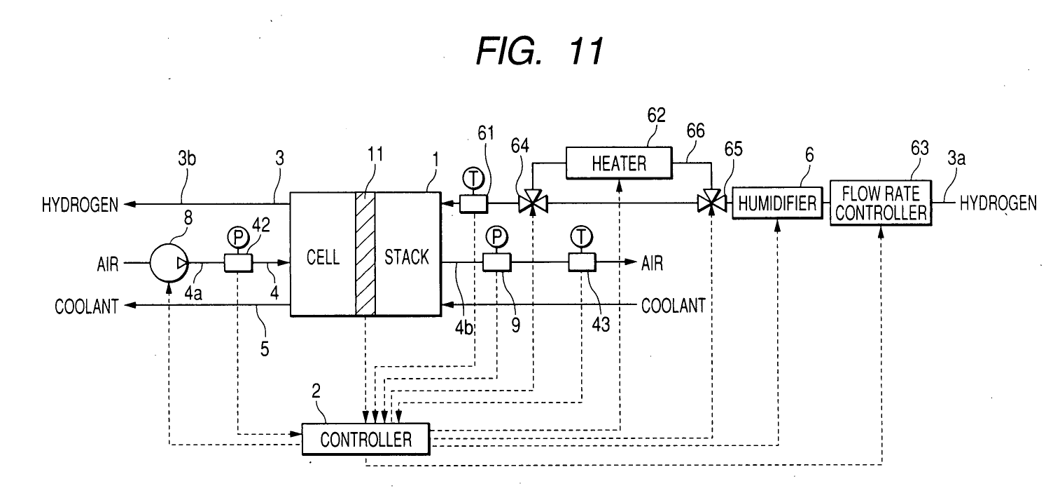

FIG. 11 shows a fuel cell system according to the sixth embodiment of the invention which is, unlike the first to fifth embodiments, designed to increase an evaporated amount of water in the hydrogen flow path 23 more than that in the air flow path 24 of the cells 20. This embodiment is different in portions of the water-removing program to be executed by the controller 2 from the fourth and fifth embodiments. The same reference numbers as employed in FIG. 7 refer to the same parts, and explanation thereof in detail will be omitted here.

The fuel cell system has a temperature sensor 61, a hydrogen gas heater 62, and a hydrogen gas flow rate controller 63 disposed in the hydrogen supply line 3a instead of the hydrogen pressure regulator 7 and the hydrogen gas sensor 41, as used in the fourth embodiment of FIG. 7. The temperature sensor 61, the hydrogen gas heater 62, the humidifier 6, and the hydrogen gas flow rate controller 63 are arrayed in this order in an upstream direction from the fuel cell stack 1.

The temperature sensor 61 works to measure the temperature in the hydrogen supply line 3a and output a signal indicative thereof to the controller 2.

The hydrogen gas heater 62 is disposed in a heating bypass line 66 extending in parallel to the hydrogen supply line 3a. The heating bypass line 66 connects with the hydrogen supply line 3a through selector valves 64 and 65 which are controlled in operation by the controller 2. Specifically, the selector valves 64 and 65 are responsive to switch signals from the controller 2 to direct a flow of the hydrogen gas to the hydrogen gas heater 62 to heat the hydrogen gas to be fed to the fuel cell stack 1.

The hydrogen gas flow rate controller 63 is responsive to a command signal from the controller 2 to control the flow rate of the hydrogen gas flowing through the hydrogen supply line 3a.

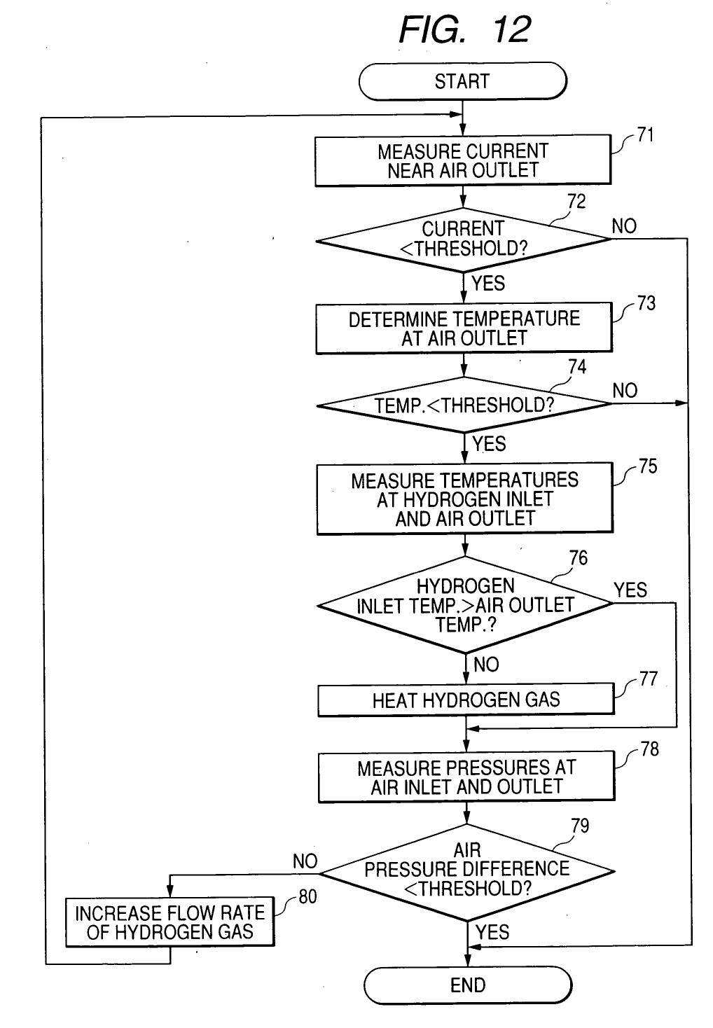

The controller 2 is designed to perform a water-removing program, as illustrated in FIG. 12. The program is initiated upon start of operation of the fuel cell stack 1 and carried out at a given interval.

Steps 71, 72, 73, and 74 are identical in operation with steps 51, 52, 53, and 54 in FIG. 9 to determine whether the water exists in the air flow path 24 of the cells 20 or not, and explanation thereof in detail will be omitted here.

If a NO answer is obtained in step 74 meaning that an unwanted amount of water does not exist in the air flow path 24, then the routine terminates. Alternatively, if a YES answer is obtained, then the routine proceeds to step 75 wherein the controller 2 samples outputs from the temperature sensor 61 installed in the hydrogen supply line 3a and the temperature sensor 43 installed in the air drain line 4b. The temperature in the hydrogen supply line 3a may be considered to be equivalent to that in the hydrogen inlet 22a of the hydrogen flow path 23 of the cells 20. The temperature in the air drain line 4b may be considered to be equivalent to that in the air outlet 22e of the air flow path 24 of the cells 20.

The routine proceeds to step 76 wherein it is determined whether the temperature in the hydrogen supply line 3a (i.e., the temperature in the hydrogen inlet 22a) is greater than that in the air drain line 4b (i.e., the temperature in the air outlet 22e) or not.

The hydrogen inlet 22a of each of the cells 20 is located closer to the air outlet 22e than the air inlet 22b. The comparison between the temperatures in the hydrogen inlet 22a and the air outlet 22e, thus, enables a decision of whether the temperature of the surface of the electrolyte film of the cell 20 facing the hydrogen flow path 23 is higher than that of the opposite surface of the electrolyte film facing the air flow path 24 or not.

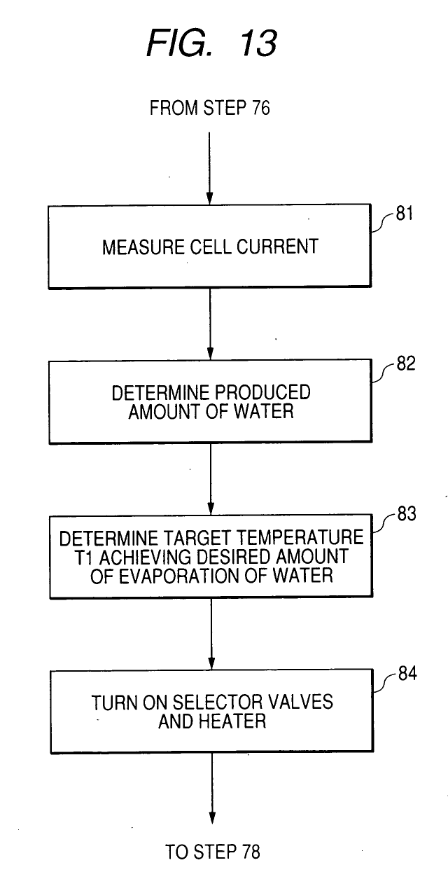

If a YES answer is obtained in step 76 meaning that the temperature of the hydrogen inlet 22a is higher, then the routine proceeds directly to step 78. Alternatively, if a NO answer is obtained, then the routine proceeds to step 77 wherein the controller 2 heats the hydrogen gas flowing through the hydrogen supply line 3a to elevate the temperature in the hydrogen inlet 22a of the hydrogen flow path 23 of each of the cells 20 above that in the air outlet 22e of the air flow path 24. Specifically, after entering step 75, the routine proceeds to step 81, as illustrated in FIG. 13, wherein the controller 2 samples an output from the current sensor plate 11 to determine the amount of current, as produced by the whole of the cell 20.

The routine proceeds to step 82 wherein the amount of water, as produced by the power generation of the cell 20, is calculated based on the amount of current, as determined in step 81.

The routine proceeds to step 83 wherein the target temperature T₁ in the hydrogen flow path 23 is calculated based on the amount of water determined in step 82.

Specifically, the target temperature T₁ is determined which will achieve evaporation of the amount of water=a produced amount of water−a retained amount of water. The amount of water to be evaporated is a total amount of water to be evaporated in the hydrogen flow path 23 and the air flow path 24 of the cell 20. The retained amount of water is the amount of water retained within the electrolyte film of the cell 20. The evaporated amount of water has a relation, as described below, to the vapor pressure. The target temperature T₁ may, thus, be determined by calculating the vapor pressure corresponding to the amount of water required to be evaporated and then finding a value of temperature which will produce such a vapor pressure.

The relation between the evaporated amount of water and the vapor pressure in the hydrogen flow path 23 of the cell 20 will be discussed here. The evaporated amount of water m in the hydrogen flow path 23 and the saturated vapor pressure in the hydrogen flow path 23 bear a relation expressed by equation 1 below.
m=hp(w1−w^{∞}) (1)
where h is the mass transmissibility (also called mass transfer coefficient) of water, ρ is the density of water, w1 is the vapor pressure on the surface of the MEA 21 of the cell 20 in the hydrogen flow path 23, and w^{∞} is the saturated vapor pressure in the hydrogen flow path 23.

Eq. (1) shows that increasing of the mass transmissibility h results in an increased amount of water evaporated per unit time into the hydrogen gas flowing through the hydrogen flow path 23.

The Sherwood number Sh for a turbulent flow associated with the mass transmissibility is expressed by equation (2) below. The Sherwood number Sh for a laminar flow is expressed by equation (3) below.
Sh=0.022Re0.8Sc0.5=h/D (2)
Sh=h/D=4.36 (3)
where Re is the Reynolds' number, Sc is the Schmidt number, and D is the mass diffusion coefficient.

The Reynolds' number Re and the Schmidt number Sc are given by equations (4) and (5) below.
Sc=ν/D (4)
Re=ud/ν (5)
where ν is the coefficient of kinematic viscosity, u is the flow rate of the hydrogen gas, d is the diameter of the hydrogen flow path 23.

After the temperature T₁ in the hydrogen flow path 23 is calculated in step 83, the routine proceeds to step 84 wherein the controller 2 outputs on-signals to the selector valves 64 and 65 and the hydrogen gas heater 62 to switch the flow of the hydrogen gas from the hydrogen supply line 3a to the heating bypass line 66. The hydrogen gas heater 62 heats the flow of the hydrogen gas so that the hydrogen gas flowing in the hydrogen flow path 23 of the cells 20 will have the temperature T₁, as calculated in step 83.

The routine proceeds to step 78 of FIG. 12 wherein the controller 2, like step 56 of FIG. 9, samples outputs from the air pressure sensor 42 installed in the air supply line 4a and the air pressure sensor 9 installed in the air drain line 4b. Usually, the pressure of the air in the air supply line 4a is equivalent to the pressure in the air inlet 22b of the air flow path 24 of the cells 20. The pressure of the air in the air drain line 4b is equivalent to the pressure in the air outlet 22e of the air flow path 24 of the cells 20. The controller 2, therefore, knows the pressures of the air in the air inlet 22b and the air outlet 22e of the cells 20 from the outputs from the air pressure sensors 42 and 9.

The routine proceeds to step 79 wherein it is determined, like step 57 of FIG. 9, whether a difference between the outputs, as sampled in step 78, that is, a difference in pressure between the air inlet 22b and the air outlet 22e of the air flow path 24 of the cells 20 has decreased below that before the flow of the hydrogen gas to the fuel cell stack 1 is heated in step 77 or not. The determination in step 79 is made to determine whether the water in the air flow path 24 of the cells 20 has been removed or not.

If a YES answer is obtained in step 79 meaning that the pressure difference between the air inlet 22b and the air outlet 22e of the air flow path 24 has decreased, so that the water has disappeared from the air flow path 24 of the cells 20, then the routine terminates. The controller 2 turns off the hydrogen gas heater 62. Alternatively, if NO answer is obtained, then the routine proceeds to step 80 wherein the controller 2 actuates the hydrogen gas flow rate controller 63 to increase the amount of hydrogen gas to be supplied to the fuel cell stack 1 through the hydrogen supply line 3a. Such an increase in the hydrogen gas is preferably determined to satisfy a relation of the evaporated amount of water in the hydrogen flow path 23 of the cell 20 (i.e., the diffused amount of mass)>the amount of water existing in the air flow path 24. For instance, the controller 2 preferably determines the amount of hydrogen gas to be supplied to the fuel cell stack 1 so as to produce the amount of water to be evaporated in the hydrogen flow path 23 that is twice that before actuation of the hydrogen gas flow rate controller 63.

The features of this embodiment will be described below.

The heating bypass line 66 is connected to the hydrogen supply line 3a through the selector valves 64 and 65. The hydrogen gas heater 62 is disposed in the heating bypass line 66. The controller 2 works to determine in step 72 whether the current, as sampled from the current sensor plate 11, is smaller than the threshold value or not and also determine in step 74 whether the temperature in the air outlet 22e of the cell 20 is smaller than the threshold value or not, thereby checking whether an unwanted amount of water exists in the air flow path 24 of the cell 20 or not. When the water is determined to exist in the air flow path 24, the controller 2 determines in step 76 whether the temperature in the hydrogen inlet 22a of the cell 20 is lower than that in the air outlet 22e or not. When such a condition is encountered, the controller 2 works in step 77 to heat the flow of hydrogen gas to the fuel cell stack 1. Specifically, the controller 2 actuates the selector valves 64 and 65 to open the heating bypass line 66 and commands the hydrogen gas heater 62 to elevate the temperature in the hydrogen flow path 23 of the cells 20 above that in the air flow path 24. This increases the saturated vapor pressure in the hydrogen flow path 23 above that in the air flow path 24, thus causing the amount of water evaporated in the hydrogen flow path 23 to increase more than that in the air flow path 24. This will cause the amount of water on the surface of the electrolyte film of the cells 20 facing the hydrogen flow path 23 to decrease below that on the surface thereof facing the air flow path 24, so that the concentration of water in the surface of the electrolyte film facing the hydrogen flow path 23 becomes lower than that in the surface thereof facing the air flow path 24, thus resulting in diffusion of the water from the surface of the electrolyte film facing the air flow path 24 to the surface thereof facing the hydrogen flow path 23. Specifically, the water is transferred from the surface of the electrolyte film facing the air flow path 24 to the surface thereof facing the hydrogen flow path 23.

The hydrogen gas flow rate controller 63 is disposed in the hydrogen supply line 3a. The controller 2 determines in step 79 that a difference in pressure between the air inlet 22b and the air outlet 22e of the air flow path 24 of the cells 20 has not decreased below a threshold value (i.e., that before the flow of the hydrogen gas to the fuel cell stack 1 is heated in step 77), the controller 2 actuates the hydrogen gas flow rate controller 63 to increase the flow rate of the hydrogen gas to be supplied to the fuel cell stack 1. Specifically, when the difference in pressure between the air inlet 22b and the air outlet 22e of the air flow path 24 is greater than the threshold value, that is, when there is an undesirable amount of water in the air flow path 24, the controller 2 increases the flow rate of the hydrogen gas to be supplied to the fuel cell stack 1 through the fuel supply line 3a to increase the velocity of flow of the hydrogen gas in the hydrogen supply path 23, thereby increasing the amount of water to be evaporated in the hydrogen flow path 23 more than that in the air flow path 24. This will cause the amount of water on the surface of the electrolyte film of the cells 20 facing the hydrogen flow path 23 to decrease below that on the surface thereof facing the air flow path 24, thus resulting in diffusion of the water from the surface of the electrolyte film facing the air flow path 24 to the surface thereof facing the hydrogen flow path 23 within the electrolyte film. Specifically, the water is transferred through the electrolyte film to the surface thereof facing the hydrogen flow path 23. This prevents the water, as produced by the air electrode of each of the cells 20, from vaporizing and mixing with the air flowing through the air flow path 24, thereby avoiding a drop in apparent concentration of oxygen contained in the whole of air within the fuel cell stack 1, which ensures the stability of operation of the fuel cell stack 1 regardless of whether the air to be supplied to the fuel cell stack 1 is humidified or not.

The fuel cell system of this embodiment may be modified as described below.

The controller 2, as described above, works to heat the hydrogen gas in step 77 and also increase the flow rate thereof in step 80 in order to remove the water from the air flow paths 24 of the cells 20, but however, may be designed to perform only either of such operations.

For instance, when it is determined in step 79 that the difference in pressure between the air inlet 22b and the air outlet 22e of the air flow path 24 of the cells 20 has not decreased below that before the flow of the hydrogen gas to the fuel cell stack 1 is heated in step 77, the controller 2 may return the routine back to step 71 without performing step 80.

Alternatively, the controller 2 may omit step 80 and increase the flow rate of the hydrogen gas in step 77 without heating it. When it is determined in step 79 that the difference in pressure between the air inlet 22b and the air outlet 22e of the air flow path 24 of the cells 20 has not decreased below that before the flow rate of the hydrogen gas to the fuel cell stack 1 is increased in step 77, the controller 2 returns the routine back to step 71.

Further, instead of the determination in step 79, the controller 2 may determine whether the amount of electricity generated by the cells 20 is smaller than a threshold value (e.g., 0.5 A/m²) or not. When it is determined that the amount of electricity generated by the cells 20 is smaller than the threshold value, the controller 2 increases the flow rate of the hydrogen gas in step 80.

The fuel cell system of each of the above embodiments may be modified as described below.

The electrolyte of each of the cells 20 is, as described above, made of a polymer electrolyte film, but however, may alternatively be implemented by another type of electrolyte needed to be controlled in amount of water.

The fuel cell system is designed not to humidify the air in order to increase the concentration of oxygen in the fuel cell stack 1, but however, it may be constructed to control the quantity of humidification of the air in a range lower than a typical one.

The fuel cell system may be constructed to have a combination of the features of one of the first to third embodiments and the features of either of the fourth and firth embodiments or a combination of the features of one of the first to third embodiments and the features of the sixth embodiment.

The fuel cell system may be constructed to use a hydride gas instead of the hydrogen gas as the fuel.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A fuel cell system comprising:
a fuel cell stack made up of a plurality of cells each including a fuel gas flow path through which fuel gas flows and an air flow path through which air flows, each of the cells also including a fuel electrode exposed to the fuel gas flow path, an air electrode exposed to the air flow path, and an electrolyte disposed between the fuel electrode and the air electrode;
an air supply line through which the air is supplied to the air flow path of each of the cells;
an air drain line through which the air flowing out of the air flow paths of the cells is drained;
a fuel supply path through which the fuel gas is supplied to the fuel gas flow path of each of the cells;
an air flow rate regulator working to regulate a flow rate of the air flowing through said air drain line; and
a controller working to determine whether the electrolyte of at least one of the cells is being dried or not, when the electrolyte is determined to be being dried, said controller actuating said air flow rate regulator to elevate a pressure of the air in the air flow path of each of the cells above a level required in a normal operation of said fuel cell stack to decrease a velocity of flow of the air in the air flow path.

2. A fuel cell system as set forth in claim 1, wherein said air flow rate regulator is implemented by a pressure regulator working to regulate a pressure of the air flowing in said air drain line.

3. A fuel cell system as set forth in claim 1, further comprising a current sensor designed to measure an electric current, as generated in an area defined near an air inlet of the air flow path of at least one of the cells, and wherein said controller samples the electric current, as measured by said current sensor, to determine whether the electrolyte of at least one of the cells is being dried or not.

4. A fuel cell system as set forth in claim 1, further comprising a voltage sensor working to measure a voltage, as generated by one of the cells, and wherein said controller compares the voltage, as measured by said voltage sensor, with a given threshold value to determine whether the electrolyte of at least one of the cells is being dried or not.

5. A fuel cell system as set forth in claim 1, further comprising a total voltage sensor working to measure a total voltage, as generated by the cells, and wherein said controller compares the voltage, as measured by said total voltage sensor, with a given threshold value to determine whether the electrolytes of the cells are being dried or not.

6. A fuel cell system as set forth in claim 1, further comprising an impedance measuring circuit working to measure an impedance of one of the cells, and wherein said controller compares the impedance, as measured by said impedance measuring circuit, with a given threshold value to determine whether the electrolyte of at least one of the cells is being dried or not.

7. A fuel cell system as set forth in claim 1, further comprising a pressure difference regulator working to regulate a difference in pressure between the air in the air flow paths of the cells and the fuel gas in the fuel gas flow paths of the cells, and wherein said controller works to determine whether water exists in the air flow paths or not, when it is determined that the water exists in the air flow paths, said controller actuating said pressure difference regulator to elevate the pressure of the air in the air flow path of each of the cells above a pressure of the fuel gas in the fuel gas flow path of each of the cells.

8. A fuel cell system as set forth in claim 7, wherein said pressure difference regulator is implemented by an air flow rate regulator disposed in said air drain line, and wherein said controller actuates the air flow rate regulator to increase the pressure in the air flow paths of the cells more than that in the fuel gas flow paths.

9. A fuel cell system as set forth in claim 7, further comprising a first pressure sensor working to measure a pressure of the air in said air supply line and a second pressure sensor working to measure a pressure of the air in said air drain line, and wherein when a difference between the pressures, as measured by said first and second pressure sensors, has decreased below that before said controller elevates the pressure of the air in the air flow path of each of the cells, said controller stops elevating the pressure of the air in the air flow path.

10. A fuel cell system as set forth in claim 1, further comprising an evaporation controller working to increase an amount of water to be evaporated in the fuel gas flow paths of the cells above that in the air flow paths of the cells, and wherein said controller works to determine whether there is water in the air flow paths or not, when it is determined that the water exists in the air flow paths, said controller actuates said evaporation controller to increase the amount of water to be evaporated in the fuel gas flow paths above that in the air flow paths.

11. A fuel cell system as set forth in claim 10, wherein said evaporation controller includes a gas heater working to heat the fuel gas flowing through said fuel gas supply line, and wherein said controller actuates the gas heater to heat the fuel gas flowing through said fuel gas supply line to elevate a temperature in the fuel gas flow paths above that in the air flow paths, thereby increasing the amount of water to be evaporated in the fuel gas flow paths above that in the air flow paths.

12. A fuel cells system as set forth in claim 11, further comprising a cell current determining circuit working to determine an electric current generated by the cells, and wherein said controller determines an amount of water having been produced in the cells based on the electric current, as determined by said cell current determining circuit, calculate a desired amount of water to be evaporated in the fuel gas flow paths based on the produced amount of water and an amount of water to be retained by the electrolytes of the cells, and determine a target temperature in the fuel gas flow paths needed to achieve evaporation of the desired amount of water, said controller actuating the gas heater to heat the fuel gas flowing through said fuel gas supply line so as to establish the target temperature in the fuel gas flow paths.

13. A fuel cell system as set forth in claim 10, wherein said evaporation controller includes a gas flow rate controller working to control a flow rate of the fuel gas flowing through said fuel gas supply line, and wherein said controller actuates the gas flow controller to increase an amount of the fuel gas supplied to said fuel cell stack, thereby increasing the amount of water to be evaporated in the fuel gas flow paths above that in the air flow paths.

14. A fuel cell system as set forth in claim 10, further comprising a first pressure sensor working to measure a pressure of the air in said air supply line and a second pressure sensor working to measure a pressure of the air in said air drain line, and wherein when a difference between the pressures, as measured by said first and second pressure sensors, has decreased below that before said controller increases the amount of water to be evaporated in the fuel gas flow paths, said controller stops increasing the amount of water to be evaporated in the fuel gas flow paths.

15. A fuel cell system as set forth in claim 7, further comprising a current sensor working to measure an electric current generated in an area defined near an air outlet of the air flow path of at least one of the cells and a temperature sensor working to measure a temperature in the air outlet of the air flow path, and wherein said controller determines whether the water exists in the air flow paths or not based on the electric current, as measured by the current sensor, and the temperature, as measured by the temperature sensor.

16. A fuel cell system as set forth in claim 7, further comprising a cell voltage sensor working to measure a voltage, as developed by one of the cells, and wherein said controller compares the voltage, as measured by said cell voltage sensor, with a given threshold value to determine whether the water exists in the air flow paths or not.

17. A fuel cell system as set forth in claim 7, further comprising a total voltage sensor working to measure a total voltage, as generated by the cells, and wherein said controller determines whether the water exists in the air flow paths or not based on the measured total voltage.

18. A fuel cell system as set forth in claim 1, further comprising a humidifier working to humidify the fuel gas flowing through said fuel gas supply line into said fuel cell stack.

19. A fuel cell system comprising:
a fuel cell stack made up of a plurality of cells each including a fuel gas flow path through which fuel gas flows and an air flow path through which air flows, each of the cells also including a fuel electrode exposed to the fuel gas flow path, an air electrode exposed to the air flow path, and an electrolyte disposed between the fuel electrode and the air electrode;
an air supply line through which the air is supplied to the air flow path of each of the cells;
an air drain line through which the air flowing out of the air flow paths of the cells is drained;
a fuel supply path through which the fuel gas is supplied to the fuel gas flow path of each of the cells;
a pressure difference regulator working to regulate a difference in pressure between the air in the air flow paths of the cells and the fuel gas in the fuel gas flow paths of the cells; and
a controller working to determine whether water exists in the air flow paths or not, when it is determined that the water exists in the air flow paths, said controller actuating said pressure difference regulator to elevate the pressure of the air in the air flow path of each of the cells above a pressure of the fuel gas in the fuel gas flow path of each of the cells.

20. A fuel cell system as set forth in claim 19, wherein said pressure difference regulator is implemented by an air flow rate regulator disposed in said air drain line, and wherein said controller actuates the air flow rate regulator to increase the pressure in the air flow paths of the cells more than that in the fuel gas flow paths.

21. A fuel cell system as set forth in claim 19, further comprising a first pressure sensor working to measure a pressure of the air in said air supply line and a second pressure sensor working to measure a pressure of the air in said air drain line, and wherein when a difference between the pressures, as measured by said first and second pressure sensors, has decreased below that before said controller elevates the pressure of the air in the air flow path of each of the cells, said controller stops elevating the pressure of the air in the air flow path.

22. A fuel cell system as set forth in claim 19, further comprising a current sensor working to measure an electric current generated in an area defined near an air outlet of the air flow path of at least one of the cells and a temperature sensor working to measure a temperature in the air outlet of the air flow path, and wherein said controller determines whether the water exists in the air flow paths or not based on the electric current, as measured by the current sensor, and the temperature, as measured by the temperature sensor.

23. A fuel cell system as set forth in claim 19, further comprising a cell voltage sensor working to measure a voltage, as developed by one of the cells, and wherein said controller compares the voltage, as measured by said cell voltage sensor, with a given threshold value to determine whether the water exists in the air flow paths or not.

24. A fuel cell system as set forth in claim 19, further comprising a total voltage sensor working to measure a total voltage, as generated by the cells, and wherein said controller determines whether the water exists in the air flow paths or not based on the measured total voltage.

25. A fuel cell system as set forth in claim 19, further comprising a humidifier working to humidify the fuel gas flowing through said fuel gas supply line into said fuel cell stack.

26. A fuel cell system comprising:
a fuel cell stack made up of a plurality of cells each including a fuel gas flow path through which fuel gas flows and an air flow path through which air flows, each of the cells also including a fuel electrode exposed to the fuel gas flow path, an air electrode exposed to the air flow path, and an electrolyte disposed between the fuel electrode and the air electrode;
an evaporation controller working to increase an amount of water to be evaporated in the fuel gas flow paths of the cells above that in the air flow paths of the cells; and
a controller working to determine whether there is water in the air flow paths or not, when it is determined that the water exists in the air flow paths, said controller actuating said evaporation controller to increase the amount of water to be evaporated in the fuel gas flow paths above that in the air flow paths.

27. A fuel cell system as set forth in claim 26, wherein said evaporation controller includes a gas heater working to heat the fuel gas flowing through said fuel gas supply line, and wherein said controller actuates the gas heater to heat the fuel gas flowing through said fuel gas supply line to elevate a temperature in the fuel gas flow paths above that in the air flow paths, thereby increasing the amount of water to be evaporated in the fuel gas flow paths above that in the air flow paths.

28. A fuel cells system as set forth in claim 27, further comprising a cell current determining circuit working to determine an electric current generated by the cells, and wherein said controller determines an amount of water having been produced in the cells based on the electric current, as determined by said cell current determining circuit, calculate a desired amount of water to be evaporated in the fuel gas flow paths based on the produced amount of water and an amount of water to be retained by the electrolytes of the cells, and determine a target temperature in the fuel gas flow paths needed to achieve evaporation of the desired amount of water, said controller actuating the gas heater to heat the fuel gas flowing through said fuel gas supply line so as to establish the target temperature in the fuel gas flow paths.

29. A fuel cell system as set forth in claim 26, wherein said evaporation controller includes a gas flow rate controller working to control a flow rate of the fuel gas flowing through said fuel gas supply line, and wherein said controller actuates the gas flow controller to increase an amount of the fuel gas supplied to said fuel cell stack, thereby increasing the amount of water to be evaporated in the fuel gas flow paths above that in the air flow paths.

30. A fuel cell system as set forth in claim 26, further comprising a first pressure sensor working to measure a pressure of the air in said air supply line and a second pressure sensor working to measure a pressure of the air in said air drain line, and wherein when a difference between the pressures, as measured by said first and second pressure sensors, has decreased below that before said controller increases the amount of water to be evaporated in the fuel gas flow paths, said controller stops increasing the amount of water to be evaporated in the fuel gas flow paths.

31. A fuel cell system as set forth in claim 26, further comprising a current sensor working to measure an electric current generated in an area defined near an air outlet of the air flow path of at least one of the cells and a temperature sensor working to measure a temperature in the air outlet of the air flow path, and wherein said controller determines whether the water exists in the air flow paths or not based on the electric current, as measured by the current sensor, and the temperature, as measured by the temperature sensor.

32. A fuel cell system as set forth in claim 26, further comprising a cell voltage sensor working to measure a voltage, as developed by one of the cells, and wherein said controller compares the voltage, as measured by said cell voltage sensor, with a given threshold value to determine whether the water exists in the air flow paths or not.

33. A fuel cell system as set forth in claim 26, further comprising a total voltage sensor working to measure a total voltage, as generated by the cells, and wherein said controller determines whether the water exists in the air flow paths or not based on the measured total voltage.

34. A fuel cell system as set forth in claim 26, further comprising a humidifier working to humidify the fuel gas flowing through said fuel gas supply line into said fuel cell stack.
